(19) United States
(12) Patent Application Publication
(10) Pub. No.: US 2012/0194648 A1
(43) Pub. Date: Aug. 2, 2012

(54) VIDEO/ AUDIO CONTROLLER

(75) Inventor: Nittai Hofshi, Herzliya (IL)

(73) Assignee: AM INTERACTIVE TECHNOLOGY LTD., Herzliya (IL)

(21) Appl. No.: 13/363,536

(22) Filed: Feb. 1, 2012

Related U.S. Application Data
(60) Provisional application No. 61/438,266, filed on Feb. 1, 2011.

(51) Int. Cl. H04N 5/44; H04N 13/02

(52) U.S. Cl. 348/46; 348/734; 348/E05.096; 348/E13.074

(57) ABSTRACT

An apparatus for controlling video and/or audio material, the apparatus comprising: at least one sensor that generates a signal responsive to a physiological parameter in a user's body; a processor, that receives the signal and determines an emotional state of the user responsive to the signal; and a controller that controls the V/A material in accordance with the emotion state of the user.

### CROSS-REFERENCES TO RELATED APPLICATIONS

The present application claims benefit under 35 U.S.C. §119(e) of U.S. Provisional Application 61/438,266 filed Feb. 1, 2011 the entire content of which is incorporated herein by reference.

### FIELD

Embodiments of the invention relate to methods and devices for modifying video and/or audio material in real time.

### BACKGROUND

Digital video and/or audio material has provided not only an abundance of material for entertainment, advertising, and education but also many different ways of filtering the material so that it suits a person's needs and preferences. For example, a person may readily choose a movie via the internet according to movie genre, language, actors in the movie, or a production year. Queries for specific types of information are readily drafted for accessing specific types of information. And recommender systems commonly acquire explicit and implicit information that characterizes a population of people and individuals in the population that is used to recommend video and/or audio material to an individual.

### SUMMARY

An embodiment of the invention provides an emotion interface apparatus, that operates to interface emotions of a person, hereinafter also a “user”, interacting with video and/or audio (video/audio) material, and modifies the video/audio (V/A) material in real time responsive to the emotions. V/A material refers to any of various visual and/or audio materials with which a user may interact, such as, by way of example, a movie, computer game, audio track, image, presentation, etc.

In an embodiment of the invention, the apparatus comprises at least one contact sensor and/or at least one non-contact sensor that generates values, “data”, for at least one physiological parameter, which is usable to provide an indication of the user's emotions. By way of example, the physiological parameter may comprise the user's electrical skin conductivity, skeletal muscle tension, heart rate, temperature, and/or skin color. Optionally, the at least one physiological parameter comprises a user's facial micro-expressions. The apparatus includes a controller having a processor for processing the physiological data to determine an emotional state of the user, and for modifying the V/A material in real time responsive to the determined emotional state.

In an embodiment of the invention, the controller processes the received physiological data to generate a vector, hereinafter referred to as an emotion state vector (ESV), which comprises a plurality of components and provides a measure of an emotional state of the user. In an embodiment, the plurality of components comprises an arousal component and an attitude component. A value for a magnitude of the arousal component provides a measure of intensity or challenge that the user feels while engaging with the V/A material. A value for a magnitude of the attitude component provides a measure of satisfaction that the user experiences in engaging with the V/A material. The controller modifies the V/A material responsive to the ESV components.

In an embodiment, the controller modifies the V/A material responsive to a magnitude and direction of the ESV. Optionally, the ESV is a vector in an R² “emotion” space having a Euclidean norm, and has a magnitude equal to a square root of a sum of the squares of the magnitudes of the arousal and attitude components. The ESV has a direction in the emotion space defined by an angle whose tangent is equal to a ratio between the magnitudes of the arousal and attitude components. Different regions of the emotion space, associated with different values for arousal and attitude, are considered to represent different emotional states, such as for example, boredom, relaxation, or anxiety.

According to an embodiment, a sequence of data defining V/A material is accompanied by an “emotion trajectory” having a sequence of data defining an emotional profile. Optionally, the V/A material is included in a sequence of V/A data frames, accompanied by emotion data frames associated with the V/A material in the V/A frames. The emotion data frames, define the emotion trajectory.

The emotion trajectory comprises emotion data that streams in synchrony with the V/A frames. The emotion data in each emotion data frame may define at least one “V/A emotion zone”, in emotion space for at least one V/A frame with which it is synchronized. Optionally, the at least one V/A emotion zone, hereinafter a “frame emotion zone” (FEZ), comprises an expected range of emotional states for a user engaging with the V/A material in the V/A data frames. Optionally, the FEZ defines extreme emotional responses to the V/A data frames.

For each V/A data frame, the emotion interface apparatus determines an emotion state vector (ESV) of the user and locates a region, hereinafter an emotion focal region (EFR), in emotion space to which the ESV points. In an embodiment the emotion interface apparatus determines if and how to modify the V/A stream responsive to a relationship between the user EFR and the FEZ.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

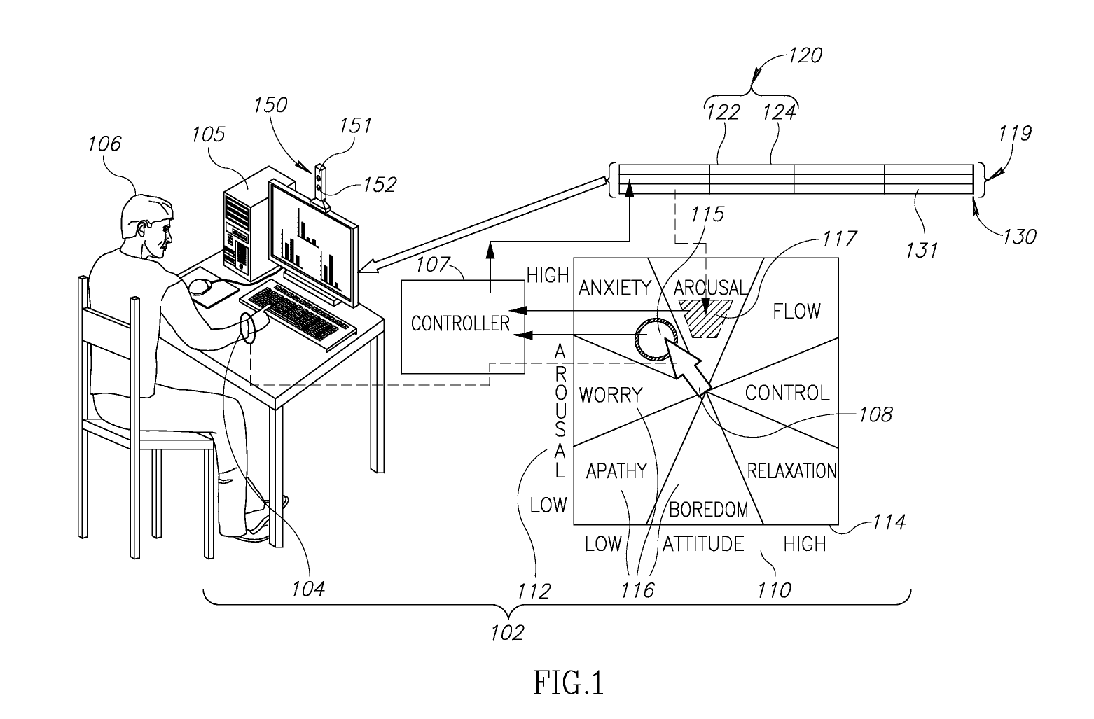

An embodiment of the invention will be further understood and appreciated from the following detailed description taken in conjunction with FIG. 1, which schematically shows an emotion interface apparatus constructed and operative in accordance with an embodiment of the invention.

### DETAILED DESCRIPTION

An embodiment of the invention relates to an emotion interface apparatus (hereinafter also “EI apparatus”) for controlling a V/A stream provided by a V/A device, in accordance with an emotional state of a user. The EI apparatus receives indications of the emotional state of a user of the V/A device by measuring changes in his or her physiological characteristics, such as, heart rate, peripheral vasoconstriction (SCA), electro dermal activity (EDA), galvanic skin response (GSR), etc. In accordance with the indications of the emotional state of the user, the EI apparatus may modify the V/A stream provided by the V/A device.

For example, assume a V/A device comprising an audio device, such as a music player, is coupled to the EI apparatus and playing music for a user. If the EI apparatus receives an indication that the user is bored with the music, the EI apparatus may control the audio device to modify the music so as to improve the user's interest in the music being played.

By way of another example, an EI apparatus in accordance with an embodiment of the invention may be coupled to a game console interfacing a user with a video game, and may modify the level of difficulty of challenges with which the video game challenges the user responsive to the user's emotional state. If the EI apparatus receives an indication that the user is negatively or unduly stressed by the game, the apparatus may change the level of difficulty of the game.

FIG. 1 schematically shows a user 106 using an EI apparatus 102 constructed and operative in accordance with an embodiment of the invention. EI apparatus 102 is coupled to a V/A device, schematically shown as a computer 105, displaying V/A material, such as a video game or a movie.

EI apparatus 102 includes a contact sensor 104 and a non-contact sensor 150, in accordance with an embodiment of the invention for sensing at least one physiological parameter of the user's body. The contact sensor, is shown by way of example as a bracelet sensor worn on the wrist of user 110. Non-contact sensor 150 optionally comprises an imaging system having a three dimensional (3D) camera 151 that provides range images of user 106. Optionally, imaging system 150 comprises a picture camera 152 that provides a conventional contrast color image of user 106.

Bracelet sensor 104, comprises at least one device suitable for measuring a physiological parameter of user 106 usable to determine an emotional state of the user. Optionally, bracelet sensor 104 comprises at least one of an ECG device for measuring heart rate, a thermometer for measuring skin temperature, an acoustic detector for measuring vascular activity, or any other sensor for measuring physiological parameters, which are known in the art. In an embodiment of the invention, bracelet sensor 104, comprises a transmitter (not shown) for transmitting measurements of physiological parameters that it acquires to a controller 107 comprised in EI apparatus 102.

It is noted, that whereas the contact sensor comprised in EI apparatus is shown as a bracelet sensor 104 worn on the wrist, the contact sensor may of course be, or comprise, a device mounted to a part of the body other than the wrist. The sensor may for example comprise a device mounted to the chest for sensing breathing rate.

In an embodiment of the invention, 3D camera 151 and contrast camera 152 transmit a sequence of range and contrast images to controller 107 that are useable to determine physiological parameters and therefrom an emotional state of user 106. For example, pulse rate and possibly blood pressure may be determined from rhythmic motion of the cardiovascular system detected from range images of the user. Micro expressions indicative of a state of mind of user 106 may be determined from images that 3D camera 151 and/or contrast camera 152 acquire. Body temperature and or state of mind may be determined responsive to color composition of images of user 106 acquired by contrast camera 152.

Controller 107 processes the physiological measurements it receives from bracelet sensor 104 and images it receives from imaging system 150 to determine an emotional state of user 106 using any known method of inferring an emotional state responsive to changes in status of human physiology. For example, when a high heart rate is detected, it may be inferred that the user is aroused, and or challenged. Certain micro expressions may indicate that user 106 is frustrated or upset. As user 106 watches a movie or plays a game provided by computer 105, EI apparatus 102 may modify progress of the movie or the game in accordance with the determined emotional state of user 106.

It will be appreciated that, processing the physiological and/or image data may include calculating an average of physiological measurements taken over time, and/or by calculating a standard deviation, thereof. In addition, processing the physiological data may include comparing the data received from the sensors with pre-stored data, for example, comparing the heart rate of the user with expected heart rate values, in accordance with the user's age. Optionally, the physiological measurements of a user may be collected over time for determining a user profile. The user profile may include an expected range of values of a physiological parameter for that user. In addition, the user profile may include patterns of values of a physiological parameter of the user, characterizing the user's emotional response to the V/A material.

Determining the emotional state of the user may include determining one or more emotional parameters of the user. For example, arousal, anxiety, relaxation, apathy, etc. According to an embodiment, the emotional state is determined based on at least two emotional parameters, for example an arousal level and an attitude. The arousal level represents an intensity or challenge that the user feels while engaging with V/A material, and attitude represents a general attitude and sentiment of the user toward the V/A material with which he or she is engaging.

When the arousal level is high and the attitude is positive, the user is engaging well with the V/A material. On the other hand, when only the attitude is positive but the arousal level is low, the user may like the V/A material, but he or she might not be challenged enough, and may be bored. Similarly, when the arousal level is high and the attitude is negative, whereas the user is challenged, the user might be tense, since the material may be too difficult for him or her. In an embodiment, the V/A material may be adjusted by EI apparatus 102 to simultaneously provide a satisfactory arousal level and positive attitude for the user.

According to an embodiment, the emotional parameters are represented as an emotional state vector (ESV). Optionally, the ESV includes two components and is defined in an R² “emotion” space having a Euclidean norm. The ESV therefore has a magnitude equal to a square root of a sum of the squares of the magnitudes of the arousal and attitude components. The ESV has a direction in the emotion space defined by an angle whose tangent is equal to a ratio between the magnitudes of the arousal and attitude components.

FIG. 1, schematically shows an emotion space 110 having an arousal axis 112 and an attitude axis 114. The FIGURE shows an ESV 108 defined in the emotion space for user 106. By way of example, emotion space 110 includes a plurality of regions 116 schematically shown in space 110 that are identified with emotional states, such as, anxiety, arousal, worry, flow, apathy, boredom, etc. ESV 108 points to an emotional focal region (EFR) 115 in emotion space 110, representing a region in emotion space that is descriptive of an emotion state of user 106. A size of region EFR 115 is indicative of a variance for the emotion state. EFR 115 may be located inside one of emotional regions 116, or straddle two adjacent regions 116.

In FIG. 1, for the given configuration of emotion space, EFR 115 indicates a state of anxiety for user 106. Were the user simultaneously exhibiting strong arousal and strong satisfaction, EFR 115 would have been located in the upper right hand region of emotion space 110 and the user would be considered to be in an emotional state of “flow”, conventionally also referred to as “being in the zone”.

In response to the user's emotional state, EI apparatus 102 modifies the progression, or streaming, of V/A material provided to user 106 by computer 105 in real time. For example, in a situation for which the V/A material is a video game, if EI apparatus 102 receives indication that user 106 is distressed, the apparatus may modify the level of difficulty of the game, so as to provide the user with a material which will lower indications of user distress. By way of another example, in a situation for which the V/A material is a movie, EI apparatus 102 may modify the movie in response to the emotional state of user 106, by displaying a progression of scenes that increases the user's sense of relaxation.

In an embodiment of the invention V/A material is associated with an emotion trajectory that defines an emotion profile for the V/A material and EI apparatus 102 modifies presentation, or streaming, of the V/A material in accordance with the user's EFR. Optionally, the emotion trajectory defines expected or normative emotional states for a user of the V/A material. Optionally, the emotion trajectory defines emotional states that are extreme and/or highly undesirable.

In an embodiment of the invention, V/A material is “packaged” together with an emotion trajectory in a computer readable medium, such as a compact disc (CD), hard disc, or flash memory, that computer 105 reads to display and sound the V/A material. In an embodiment of the invention, V/A material is transmitted over the internet together with an emotion trajectory, or is transmitted over the internet for combination with an emotion trajectory independently transmitted over the internet.

In an embodiment of the invention, the emotion trajectory comprises emotion data that defines a frame emotion zone, FEZ, in emotion space 110 for each frame of V/A material. For example, for a video game, each V/A frame in the game may be associated with a predefined FEZ. Similarly, in a case of a movie, each V/A frame of the movie may be associated with a FEZ. EI apparatus 102 modifies streaming of V/A material responsive to a relationship between the user's EFR generated at a time when the user is presented with the V/A frame and the FEZ for the V/A frame provided by the emotion trajectory.

By way of example, FIG. 1 schematically shows V/A material 119 being presented to user 106 by computer 105. V/A material 119 comprises a plurality of V/A fames 120, each having a video data frame 122, and audio data frame 124. In accordance with an embodiment of the invention, V/A material 119 is associated with an emotion trajectory 130 comprising emotion data frames 131. The emotion trajectory associates an emotion data frame 131 with each V/A frame 120. In an embodiment of the invention, each emotion data frame 131 defines a FEZ for its associated V/A frame.

FIG. 1 schematically shows a FEZ 117 associated with a V/A frame for which ESV 108 and its related EFR 115 are generated. In an embodiment of the invention EI apparatus 102 controls streaming of V/A frames 120 responsive to a relationship between FEZ 117 and EFR 115. Optionally, controller 107 determines a distance between EFR 115 and FEZ 117 and controls streaming of V/A material 119 responsive to the determined distance.

It is noted that in addition to, or instead of, determining an emotional state of the user by measuring physiological parameters, EI apparatus 102 may include an interface device for manually inputting the emotional state of user 106. For example, the input means may include a switch allowing the user to select the emotion region, which best characterizes his/her emotional state. Accordingly, EI apparatus 102 can select frames 120, which are associated with the emotion region input by user 106.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. An apparatus for controlling video and/or audio (V/A) material, the apparatus comprising:
at least one sensor that generates a signal responsive to a physiological parameter in a user's body;
a processor, that receives the signal and determines an emotional state of the user responsive to the signal; and
a controller that controls the V/A material in accordance with the determined emotional state.

2. An apparatus according to claim 1 wherein the at least one sensor comprise a non-contact sensor.

3. An apparatus according to claim 2 wherein the non-contact sensor comprises an imaging system.

4. An apparatus according to claim 3 wherein the imaging system comprises a three-dimensional camera that acquires a range image of the user.

5. An apparatus according to claim 4 wherein the imaging system comprises a three-dimensional (3D) camera that acquires a series of range images of the user.

6. An apparatus according to claim 5 wherein the controller determines changes in location of regions of the user's body responsive to the ranges images to determine the physiological parameter of the user.

7. An apparatus according to claim 6 wherein the physiological parameter comprises at least one of pulse rate and blood pressure.

8. An apparatus according to claim 3 wherein the imaging system comprises a contrast camera that acquires a series of contrast images of the user.

9. An apparatus according to claim 8 wherein the controller determines changes in color of a region of the user's body responsive to the contrast images to determine a physiological parameter of the user.

10. An apparatus according to claim 1 wherein the V/A material comprises a sequence of V/A data frames comprising data responsive to which a V/A device presents a stream of V/A material to the user.

11. An apparatus according to claim 10 and comprising an emotion data frame associated with each V/A data frame, where the emotion data frame comprises data that associates an emotional state with the V/A data frame.

12. A computer readable medium comprising V/A data and emotional state data that associates an emotional state with the V/A data.

13. A computer readable medium according to claim 12 wherein the V/A data comprises a sequence of V/A data frames having data responsive to which a V/A device presents a stream of V/A material to a user.

14. A computer readable medium according to claim 13 wherein the emotional state data comprises a sequence of emotion data frames.

15. A method for controlling V/A material, the method comprising:
receiving a signal responsive to at least one physiological parameter from a sensor coupled to a user's body;
determining the emotion state of said user, in accordance with the received signal; and
controlling V/A material in accordance with the determined emotion state.

16. Apparatus for interfacing a user with V/A material, the apparatus comprising:
a wearable sensor that generates signals responsive to a physiological parameter of a user wearing the housing;
a processor that receives the sensor signals and generates signals responsive thereto representative of the user's emotional state; and
a transmitter that transmits the signals representative of the emotional state to a controller that controls presentation of the V/A material to the user responsive to the signals it receives.
